(19) United States
(12) Patent Application Publication
(10) Pub. No.: US 2026/0296466 A1
(43) Pub. Date: Oct. 1, 2026

(54) DRIVE CONTROL DEVICE, DRIVE CONTROL METHOD, AND STORAGE MEDIUM STORING DRIVE CONTROL PROGRAM

(71) Applicants: DENSO CORPORATION, Kariya-city (JP); J-QuAD DYNAMICS Inc., Tokyo (JP); AISIN CORPORATION, Kariya (JP); ADVICS CO., LTD., Kariya-city (JP); JTEKT CORPORATION, Kariya-shi (JP)

(72) Inventors: Daisuke NAGASAKA, Tokyo (JP); Takashi ASAI, Tokyo (JP)

(21) Appl. No.: 19/571,967

(22) Filed: Mar. 19, 2026

(30) Foreign Application Priority Data
Mar. 25, 2025 (JP) 2025-050296

(51) Int. Cl. B60W 50/10; B60W 30/18; B60W 50/00

(52) U.S. Cl. CPC B60W 50/10; B60W 30/18009; B60W 50/0097; B60W 2540/10; B60W 2552/20; B60W 2552/40; B60W 2720/106

(57) ABSTRACT

A drive control device is configured to determine a predicted route by predicting a route on which a vehicle drives; sequentially acquire signals detecting a road surface condition from a road surface condition detection sensor that sequentially detects the road surface condition of a road on which the vehicle is driving, and to sequentially estimate a road surface friction coefficient at a plurality of predicted positions on the predicted route; and sequentially plan a speed of the vehicle for driving the predicted route based on the road surface friction coefficient at each predicted position.

### CROSS REFERENCE TO RELATED APPLICATION

The present application is based on Japanese Patent Application No. 2025-050296 filed on Mar. 25, 2025, the disclosure of which is incorporated herein by reference.

### TECHNICAL FIELD

The present disclosure relates to a drive control device and a drive control program for controlling the speed of a vehicle.

### BACKGROUND

It is known that devices for controlling the speed of a vehicle using static information included in map information exist. For example, JP 2009-214800A discloses a device that controls the speed of a vehicle based on the speed limit of a road included in map information. The descriptions of JP 2009-214800A are incorporated herein by reference as explanations of the technical elements in this specification.

### SUMMARY

According to an aspect of the present disclosure, a drive control device includes at least one of (i) a circuit and (ii) a processor with a memory storing computer program code executable by the processor. The at least one of the circuit and the processor may be configured to cause the drive control device to: determine a predicted route by predicting a route on which a vehicle drives; sequentially acquire signals detecting a road surface condition from a road surface condition detection sensor that sequentially detects the road surface condition of a road on which the vehicle is driving, and to sequentially estimate a road surface friction coefficient at a plurality of predicted positions on the predicted route; and sequentially plan a speed of the vehicle for driving the predicted route based on the road surface friction coefficient at each predicted position.

### BRIEF DESCRIPTION OF DRAWINGS

Objects, features and advantages of the present disclosure will become more apparent from the following detailed description made with reference to the accompanying drawings. In the drawings:

FIG. 1 is a diagram showing the configuration of a vehicle drive control system according to an embodiment;

FIG. 2 is a diagram illustrating the flow of processing executed by the drive control device; and

FIG. 3 is a diagram illustrating the flow of processing subsequently executed by the drive control device following FIG. 2.

### DETAILED DESCRIPTION

In actual driving, it is necessary to consider the road surface friction coefficient when determining the drive speed. Furthermore, the road surface friction coefficient changes continuously during driving. Therefore, in the technology disclosed in a related art, depending on the road surface friction coefficient of the actual road being driven, there is a possibility that vehicle drive may become unstable.

The present disclosure provides a vehicle driving control device and a vehicle driving control program capable of suppressing instability in vehicle driving.

According to one aspect of the present disclosure, a drive control device includes: a route determination unit configured to determine a predicted route by predicting the route on which a vehicle drives; a friction estimation unit configured to sequentially acquire signals detecting a road surface condition from a road surface condition detection sensor that sequentially detects the road surface condition of a road on which the vehicle is driving, and to sequentially estimate a road surface friction coefficient at a plurality of predicted positions on the predicted route; and a speed planning unit configured to sequentially plan a speed of the vehicle for driving the predicted route based on the road surface friction coefficient at each predicted position.

According to one aspect of the present disclosure, a drive control program causes a processor to function as: a route determination unit configured to determine a predicted route by predicting the route on which a vehicle drives; a friction estimation unit configured to sequentially acquire signals detecting a road surface condition from a road surface condition detection sensor that sequentially detects the road surface condition of a road on which the vehicle is driving, and to sequentially estimate a road surface friction coefficient at a plurality of predicted positions on the predicted route; and a speed planning unit configured to sequentially plan the speed of the vehicle for driving the predicted route based on the road surface friction coefficient at each predicted position.

According to one aspect of the present disclosure, a drive control method executed by at least one of a processor and a circuit includes: determining a predicted route by predicting a route on which a vehicle drives; sequentially acquiring signals detecting a road surface condition from a road surface condition detection sensor that sequentially detects the road surface condition of a road on which the vehicle is driving; sequentially estimating a road surface friction coefficient at a plurality of predicted positions on the predicted route; and sequentially planning a speed of the vehicle for driving the predicted route based on the road surface friction coefficient at each predicted position.

According to the above driving control device and driving control program, when the vehicle drives along the predicted route, it is possible to plan a target speed corresponding to the actual road surface friction coefficient, which changes continuously. Therefore, it is possible to suppress instability that may occur when the vehicle drives at an excessively high speed.

### Embodiment

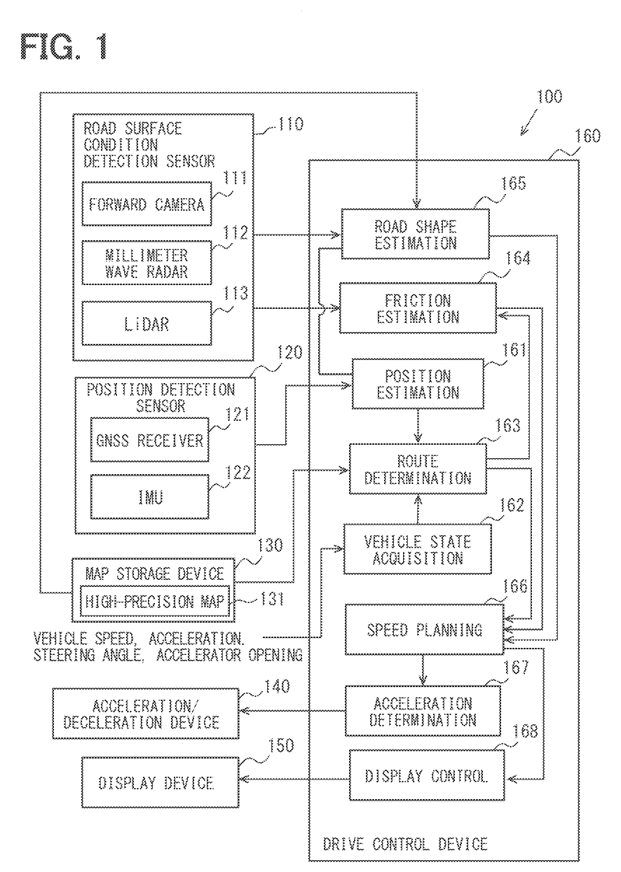

Hereinafter, the embodiment will be described with reference to the drawings. FIG. 1 is a diagram showing the configuration of a vehicle drive control system 100 according to the embodiment. The vehicle drive control system 100 is mounted on a vehicle. The vehicle equipped with the vehicle drive control system 100 is referred to as the subject vehicle. The subject vehicle can be manually operated by a driver, and speed control is performed by the vehicle drive control system 100. The vehicle drive control system 100 includes a road surface condition detection sensor 110, a position detection sensor 120, a map storage unit 130, an acceleration/deceleration device 140, a display device 150, and a drive control device 160.

The road surface condition detection sensor 110 is a sensor that detects the road surface condition of the road on which the subject vehicle is driving. The road surface condition refers to the state related to the slipperiness of the road surface. The road surface condition detection sensor 110 includes at least one of a forward camera 111, a millimeter wave radar 112, and a LiDAR 113. The forward camera 111 photographs the road surface of the road ahead of the subject vehicle on which the subject vehicle is driving. Since the road surface condition can be estimated from the brightness of the road surface image photographed by the forward camera 111, the forward camera 111 is an example of the road surface condition detection sensor 110. The millimeter wave radar 112 irradiates millimeter waves to a range ahead of the subject vehicle including the road surface of the road on which the subject vehicle is driving, and receives reflected waves of the irradiated millimeter waves. Since the intensity of the reflected waves correlates with the road surface condition, the millimeter wave radar 112 is an example of the road surface condition detection sensor 110. The LiDAR 113 irradiates laser light to a range ahead of the subject vehicle including the road surface of the road on which the subject vehicle is driving, and receives reflected light of the irradiated laser light. Since the intensity of the reflected light correlates with the road surface condition, the LiDAR 113 is an example of the road surface condition detection sensor 110.

The position detection sensor 120 sequentially detects the current position of the subject vehicle. The position detection sensor 120 may include either or both of a GNSS receiver (Global Navigation Satellite System) 121 and an IMU 122. The GNSS receiver 121 receives navigation signals transmitted by navigation satellites provided in the GNSS (Global Navigation Satellite System). Based on these navigation signals, the current position is sequentially calculated. The IMU 122 is an inertial measurement unit and sequentially acquires inertial forces acting on the subject vehicle. Since inertial forces arise with changes in the vehicle position, the current position of the subject vehicle is sequentially updated based on the inertial forces.

The map storage unit 130 is equipped with a non-volatile storage medium. A high-precision map 131 is stored in this storage medium. The high-precision map includes information on road curvature, lane-by-lane positions, and gradient. The gradient includes both the gradient in the road driving direction and the gradient in the road transverse direction. The high-precision map 131 may not be stored in the map storage unit 130, but may instead be stored in the cloud. When the high-precision map 131 is stored in the cloud, part of the data of the high-precision map 131 is sequentially acquired via wireless communication.

The acceleration/deceleration device 140 is a device for accelerating and decelerating the subject vehicle. The device for accelerating the subject vehicle includes a prime mover such as an engine or motor and a device for controlling the prime mover. The device for decelerating the subject vehicle includes a brake and a device for controlling the brake. The display device 150 is installed at a position in the subject vehicle where the driver can visually recognize it. The display device 150 may be, for example, a meter cluster display or a head-up display.

The drive control device 160 is a computer comprising, as hardware components, a processor, RAM, and non-volatile memory. The non-volatile memory stores a drive control program executed by the processor. By executing the above drive control program, the processor functions as a position estimation unit 161, a vehicle state acquisition unit 162, a route determination unit 163, a friction estimation unit 164, a road shape estimation unit 165, a speed planning unit 166, an acceleration determination unit 167, and a display control unit 168. Furthermore, by executing the above drive control program, the processor executes the drive control method.

The position estimation unit 161 sequentially acquires signals from the position detection sensor 120 and sequentially estimates the current position of the subject vehicle. The vehicle state acquisition unit 162 sequentially acquires information indicating the running state of the subject vehicle. For example, the vehicle state acquisition unit 162 sequentially acquires the vehicle speed, acceleration, steering angle, and accelerator opening of the subject vehicle. The vehicle speed, acceleration, steering angle, and accelerator opening are acquired from a vehicle speed sensor, acceleration sensor, steering angle sensor, and accelerator opening sensor, respectively.

The route determination unit 163 sequentially estimates a predicted route by predicting the route on which the subject vehicle will drive. The predicted route is the trajectory that the subject vehicle is scheduled to drive. When the subject vehicle is driving along a lane, the predicted route is the trajectory along the center of that lane. If there are no lanes on the road being driven by the subject vehicle, the predicted route is the trajectory along the center in the width direction of the road. If there are multiple lanes in the direction of drive on the road being driven by the subject vehicle and the subject vehicle is changing lanes, the predicted route is the trajectory along the center in the lane width direction after the lane change. Whether the subject vehicle is changing lanes is determined based on information acquired by the vehicle state acquisition unit 162. For example, if the steering angle deviates by a certain value or more from the direction along the currently driving lane, it is determined that the subject vehicle is changing lanes. The lane shape or road shape is acquired from the high-precision map 131 based on the position of the subject vehicle estimated by the position estimation unit 161. The length of the predicted route only needs to be sufficient to determine the predicted positions described later.

The friction estimation unit 164 sequentially estimates the road surface friction coefficient at a plurality of predicted positions on the predicted route. The road surface friction coefficient is estimated based on signals from the road surface condition detection sensor 110. The plurality of predicted positions are, for example, positions at fixed intervals along the predicted route from the current position. The fixed interval may be arbitrarily determined, such as 5 m, 10 m, or 20 m. However, since the road surface friction coefficient is used for controlling the speed of the subject vehicle, it is preferable that the fixed interval be approximately equal to the distance traveled by the subject vehicle during the update cycle of the target speed.

When estimating the road surface friction coefficient based on signals from the forward camera 111, the road surface friction coefficient is estimated from the brightness of the portion of the image photographed by the forward camera 111 corresponding to the predicted position. When estimating the road surface friction coefficient based on signals from the millimeter wave radar 112, the road surface friction coefficient is estimated based on the intensity of the reflected wave of the millimeter wave irradiated by the millimeter wave radar 112 and reflected at the predicted position. When estimating the road surface friction coefficient based on signals from the LiDAR 113, the road surface friction coefficient is estimated based on the intensity of the reflected light of the laser light irradiated by the LiDAR 113 and reflected at the predicted position. The road surface friction coefficient estimated from two or more of the forward camera 111, millimeter wave radar 112, and LiDAR 113 may be integrated to estimate the final road surface friction coefficient.

The road shape estimation unit 165 sequentially estimates the road shape of the road on which the subject vehicle is driving. The road shape includes at least one of curvature and gradient. The gradient may be either or both of the gradient in the road driving direction and the gradient in the road transverse direction. The road shape can be estimated based on the current position of the subject vehicle estimated by the position estimation unit 161 and the high-precision map 131. Additionally, the road surface condition detection sensor 110 may also serve as a road shape detection sensor, and the road shape may be estimated using signals from the road surface condition detection sensor 110.

The speed planning unit 166 sequentially plans the speed of the subject vehicle for driving the predicted route based on the road surface friction coefficient at the predicted position estimated by the friction estimation unit 164. In this embodiment, in addition to the road surface friction coefficient at the predicted position, the curvature and gradient at the predicted position are also included as input values for planning the speed of the subject vehicle for driving the predicted route. The smaller the curvature, i.e., the sharper the curve, the more the speed must be reduced. Furthermore, the greater the downhill gradient, the more positive acceleration is generated in the subject vehicle. Conversely, the greater the uphill gradient, the more negative acceleration, i.e., deceleration, is generated in the subject vehicle. These curvature and gradient factors are causes of changes in the speed of the subject vehicle. On the other hand, the smaller the road surface friction coefficient, the less force can be transmitted to the road surface. Therefore, as the road surface friction coefficient decreases, the upper limit of the absolute value of acceleration also decreases. Accordingly, the speed planning unit 166 sequentially plans the speed of the subject vehicle so that the force generated in the tires due to speed changes caused by these speed change factors does not exceed the road surface friction force determined by the road surface friction coefficient.

The speed planning unit 166 may use a single evaluation function that includes the road surface friction coefficient, curvature, gradient, and current vehicle speed as input parameters for planning the speed of the subject vehicle. This evaluation function may also include the friction circle utilization ratio. The friction circle utilization ratio is a value obtained by dividing the magnitude of the tire-generated force (numerator) by the friction circle radius (denominator). The friction circle radius is determined by the load applied to the tire and the road surface friction coefficient. The speed planning unit 166 uses a model predictive approach with the above evaluation function to calculate the target speed at each fixed time interval within the prediction horizon so that the evaluation function is minimized. The fixed time interval refers to the update cycle of the target speed. The prediction horizon is, for example, 10 seconds, and the fixed time interval is, for example, 2 seconds.

The acceleration determination unit 167 determines the acceleration to be generated in the subject vehicle. The acceleration determination unit 167 determines the acceleration required to reach the speed planned by the speed planning unit 166 (hereinafter referred to as the planned target acceleration). In addition, the acceleration determination unit 167 determines the acceleration based on the acceleration/deceleration operation performed by the driver of the subject vehicle (hereinafter referred to as the driver target acceleration). The driver’s acceleration/deceleration operation refers to accelerator and brake operations. The acceleration determination unit 167 compares the planned target acceleration and the driver target acceleration. The smaller of the two accelerations is determined as the control acceleration to be generated in the subject vehicle, and the determined control acceleration is output to the acceleration/deceleration device 140.

The display control unit 168 sequentially displays the current vehicle speed and the current friction circle utilization ratio, which is sequentially calculated by the speed planning unit 166, on the display device 150. The recommended drive speed may also be displayed on the display device 150. The recommended drive speed may use the speed planned by the speed planning unit 166 for the predicted position closest to the current position.

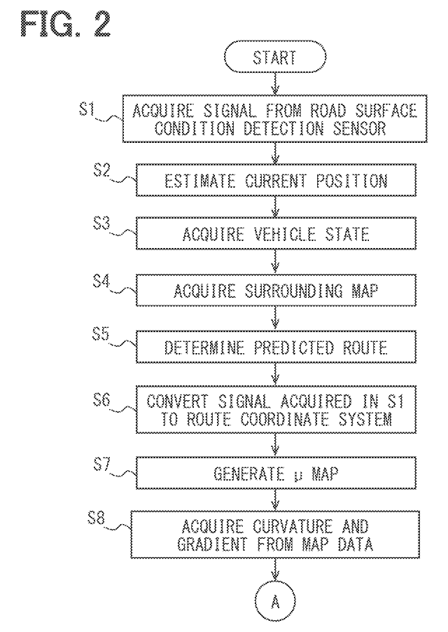

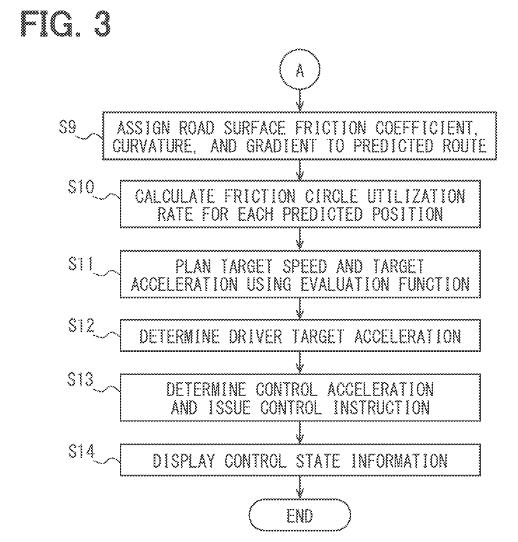

FIGS. 2 and 3 illustrate the flow of processing executed by the drive control device 160. The drive control device 160 repeatedly executes the processing shown in FIGS. 2 and 3. S1 is processing executed by the friction estimation unit 164 and the road shape estimation unit 165. In S1, signals are acquired from the road surface condition detection sensor 110. These signals include signals detecting the road surface condition and signals detecting the road shape.

In S2, the position estimation unit 161 acquires signals from the position detection sensor 120 and estimates the current position of the subject vehicle. In S3, the vehicle state acquisition unit 162 acquires signals indicating the running state of the subject vehicle. S4 and S5 are executed by the route determination unit 163. In S4, the map of the vicinity of the current position of the subject vehicle estimated in S2 is acquired from the high-precision map 131. In S5, the predicted route is determined based on the map acquired in S4 and the current position of the subject vehicle. The predicted route is the trajectory along the currently driving lane, or, if the subject vehicle is changing lanes, the trajectory along the center of the lane after the lane change.

S6 and S7 are executed by the friction estimation unit 164. In S6, the signals acquired in S1 are converted to the route coordinate system. The route coordinate system is a coordinate system in which the predicted route determined in S5 is one axis, and the direction orthogonal to the predicted route is the other axis. In S7, a μ-map is generated using the signals acquired from the forward camera 111 and converted to the coordinate system in S6. The μ-map is a map associating the road surface friction coefficient estimated from the above signals with each point on the road surface.

In S8, the road shape estimation unit 165 acquires the curvature and gradient of the predicted route from the high-precision map 131. S9 and onward are shown in FIG. 3. S9 to S11 are executed by the speed planning unit 166. In S9, the road surface friction coefficient, curvature, and gradient are assigned to the axes of the route coordinates. The road surface friction coefficient is estimated in S7. If the curvature and gradient can be acquired in S8, those values are used. If they cannot be acquired in S8, the curvature and gradient are estimated using one or both of the signals acquired from the millimeter wave radar 112 and the LiDAR 113 in S1, converted to the coordinate system in S6.

In S10, the friction circle utilization ratio is calculated for each predicted position using the information assigned to the predicted positions in S9. In S11, the friction circle utilization ratio calculated in S10 is input to a pre-set evaluation function, and the target speed for each fixed time interval within the prediction horizon is calculated. If the position of the subject vehicle determined by the fixed time interval differs from the predicted position, the friction circle utilization ratio calculated for the predicted positions before and after the position of the subject vehicle determined by the fixed time interval is interpolated or linearly interpolated to obtain the friction circle utilization ratio at the position of the subject vehicle determined by the fixed time interval. Further, in S11, the planned target acceleration required to reach the target speed is also planned.

S12 and S13 are executed by the acceleration determination unit 167. In S12, the driver target acceleration is determined from the driver’s acceleration/deceleration operation. In S13, the current target acceleration determined from the planned target acceleration in S11 and the driver target acceleration determined in S12 are compared, and the smaller acceleration is determined as the control acceleration. This control acceleration is instructed to the acceleration/deceleration device 140.

In S14, the display control unit 168 displays control state information on the display device 150. The control state information includes the current vehicle speed and the friction circle utilization ratio. The friction circle utilization ratio is displayed for each tire. The control state information may also include the recommended drive speed.

As described above, the drive control device 160 of the present embodiment determines the predicted route of the subject vehicle (S5). Furthermore, the drive control device 160 sequentially estimates the road surface friction coefficient at a plurality of predicted positions on the predicted route based on signals from the road surface condition detection sensor 110 (S1, S6, S7). Then, based on the road surface friction coefficients at the plurality of predicted positions, the target speed for the subject vehicle to drive along the predicted route is sequentially planned (S11). In this manner, it is possible to plan a target speed corresponding to the actual road surface friction coefficient, which changes sequentially, when the subject vehicle drives along the predicted route. Therefore, it is possible to suppress instability caused by the subject vehicle driving at an excessively high speed.

Additionally, the speed planning unit 166 sequentially plans the target speed using the curvature and gradient of the road at the predicted positions. By doing so, instability caused by the subject vehicle driving at an excessively high speed can be further suppressed.

Furthermore, the speed planning unit 166 sequentially plans the target speed based on an evaluation function including the friction circle utilization ratio. This also enables further suppression of instability caused by the subject vehicle driving at an excessively high speed.

Moreover, the display control unit 168 sequentially displays the current friction circle utilization ratio on the display device 150 (S14). By viewing this friction circle utilization ratio, the driver can intuitively grasp the running state of the subject vehicle. Furthermore, by displaying either or both of the current vehicle speed and the recommended drive speed on the display device 150, the driver can grasp the control state.

Additionally, the acceleration determination unit 167 compares the planned target acceleration required to reach the target speed planned by the speed planning unit 166 with the driver target acceleration, and determines the smaller acceleration as the control acceleration (S13). If the driver target acceleration is smaller, acceleration control in accordance with the driver’s intention is performed, thereby suppressing deterioration of driving comfort. If the driver target acceleration is larger, the planned target acceleration is determined as the control acceleration, thereby suppressing instability in drive.

While the embodiment has been described above, the disclosed technology is not limited to the above embodiment; the following modifications are also included within the scope of the disclosure, and various changes may be made without departing from the gist of the disclosure. In the following description, unless otherwise specified, elements having the same reference numerals as those previously used refer to the same elements as in the previous embodiment. Further, when only a part of the configuration is described, the other parts of the configuration may be applied as described in the previous embodiment.

### First Modification Example

The speed planning unit 166 may plan the speed for driving the predicted route without using either or both of the curvature and gradient at the predicted position.

### Second Modification Example

In the embodiment, the speed planning unit 166 planned the speed based on an evaluation function including the friction circle utilization ratio. However, the speed may be planned without using the friction circle utilization ratio, such that the speed does not exceed the maximum lateral acceleration determined by the road surface friction coefficient.

### Third Modification Example

The drive control device 160 only needs to include at least one of a processor and a circuit as hardware components. Therefore, the drive control device 160 is not limited to a configuration including a processor, and may be configured without a processor, with hardware circuits other than a processor, or with both a processor and hardware circuits other than a processor.

In the present disclosure, the term "processor" refers to one or more hardware processors configured to execute processing defined by computer program code (i.e., one or more instructions of a computer program) by loading such computer program code as needed. In other words, a "processor" is a hardware device that executes one or more programmed processes. Accordingly, computer program code may also be considered software that defines the processing of the processor according to its content. The "processor" may be a general-purpose or dedicated processor, such as a CPU, microprocessor, GPU, or DFP (Data Flow Processor), but is not limited thereto.

In the present disclosure, the term "memory" refers to one or more hardware memories that are non-transitory tangible recording media configured to record computer program code and/or data so as to be accessible by the processor. "Memory" may be implemented by memory technologies such as SRAM, SDRAM, non-volatile/flash-type memory, or other types of memory. The computer program code constituting the program is recorded on the memory and, when executed by the processor, enables the processor to realize various functions described above.

In the present disclosure, the term "circuit" refers to one or more hardware logic circuits configured to execute specific processing defined based on a predetermined circuit configuration. In other words (and in contrast to "processor"), "circuit" in the present disclosure refers to a hardware device that executes specific processing based on a circuit configuration, not processing defined by software such as computer program code. For example, "circuit" may include custom ICs such as ASICs (Application Specific Integrated Circuits) or FPGAs (Field Programmable Gate Arrays) designed using hardware description languages (HDL). That is, "circuit" in the present disclosure includes all hardware circuits except for the above processor that executes processing by loading computer program code.

In the present disclosure, the expression "at least one of a processor and a circuit" should be interpreted disjunctively (logical OR), and should not be interpreted as requiring at least one processor and at least one circuit.

What is claimed is:

1. A drive control device comprising:
at least one of (i) a circuit and (ii) a processor with a memory storing computer program code executable by the processor, the at least one of the circuit and the processor configured to cause the drive control device to:
determine a predicted route by predicting a route on which a vehicle drives;
sequentially acquire signals detecting a road surface condition from a road surface condition detection sensor that sequentially detects the road surface condition of a road on which the vehicle is driving, and to sequentially estimate a road surface friction coefficient at a plurality of predicted positions on the predicted route; and
sequentially plan a speed of the vehicle for driving the predicted route based on the road surface friction coefficient at each predicted position.

2. The drive control device according to claim 1, wherein
the at least one of the circuit and the processor is further configured to cause the drive control device to estimate a road shape at a predicted position, the road shape including at least one of a curvature and gradient of the road at each predicted position, and
the at least one of the circuit and the processor sequentially plans the speed of the vehicle for driving the predicted route based on the road surface friction coefficient and the road shape at each predicted position.

3. The drive control device according to claim 1, wherein
the at least one of the circuit and the processor sequentially plans the speed of the vehicle based on an evaluation function that includes a friction circle utilization ratio calculated from the road surface friction coefficient.

4. The drive control device according to claim 3, wherein
the at least one of the circuit and the processor is further configured to cause the drive control device to sequentially display a current friction circle utilization ratio on a display device visible to a driver of the vehicle.

5. The drive control device according to claim 1, wherein
the at least one of the circuit and the processor is further configured to cause the drive control device to compare a planned target acceleration required to reach the planned speed with a driver target acceleration determined based on acceleration/deceleration operation by a driver of the vehicle, and to select the smaller of the two as the acceleration to be applied to the vehicle.

6. A non-transitory computer readable storage medium storing a drive control program for causing a processor to function as:
a route determination unit configured to determine a predicted route by predicting a route on which a vehicle drives;
a friction estimation unit configured to sequentially acquire signals detecting a road surface condition from a road surface condition detection sensor that sequentially detects the road surface condition of a road on which the vehicle is driving, and to sequentially estimate a road surface friction coefficient at a plurality of predicted positions on the predicted route; and
a speed planning unit configured to sequentially plan a speed of the vehicle for driving the predicted route based on the road surface friction coefficient at each predicted position.

7. A drive control method executed by at least one of a processor and a circuit, the method comprising:
determining a predicted route by predicting a route on which a vehicle drives;
sequentially acquiring signals detecting a road surface condition from a road surface condition detection sensor that sequentially detects the road surface condition of a road on which the vehicle is driving;
sequentially estimating a road surface friction coefficient at a plurality of predicted positions on the predicted route; and
sequentially planning a speed of the vehicle for driving the predicted route based on the road surface friction coefficient at each predicted position.
